(19) United States
(12) Patent Application Publication
(10) Pub. No.: US 2016/0188884 A1
(43) Pub. Date: Jun. 30, 2016

(54) Application Decomposition Using Data Obtained From External Tools For Use In Threat Modeling

(71) Applicant: International Business Machines Corporation, Armonk, NY (US)

(72) Inventors: Khalil A. Ayoub, Ottawa (CA); Kalpana Bisht, Toronto (CA); Robert Calendino, Nepean (CA); Paul Ionescu, Kanata (CA); Richard Lee, San Jose, CA (US); Fei Liu, Bellevue, WA (US); Daniel H. Nguyen, Markham (CA); Iosif V. Onut, Ottawa (CA)

(73) Assignee: International Business Machines Corporation, Armonk, NY (US)

(21) Appl. No.: 14/956,573

(22) Filed: Dec. 2, 2015

(30) Foreign Application Priority Data
Dec. 29, 2014 (CA) 2876464

(51) Int. Cl. G06F 21/57; G06N 5/02

(52) U.S. Cl. CPC G06F 21/577; G06N 5/02; G06F 2221/034

(57) ABSTRACT

An illustrative embodiment of automated application decomposition generates a set of information specific to an application by one or more external tools. Predefined heuristics and corresponding predefined conclusions, categorized corresponding to one or more external tool domains, are applied to the set of information to produce an intermediate result. The intermediate result is converted into a set of conclusions about factors, representative of the application, used in application decomposition. The set of conclusions is exported and used to generate a model of the application. The model is a starting point for identification of threats and weaknesses specific to the application.

### CROSS-REFERENCE TO RELATED APPLICATION

This application claims priority under 35 U.S.C. §119 from Canadian Patent Application No. 2876464 filed on Dec. 29, 2014, the entire contents of which are incorporated herein by reference.

### BACKGROUND

This disclosure relates generally to threat modeling in a data processing system and more specifically to automate application decomposition for use in threat modeling in the data processing system.

Threat modeling is a process designed to provide a list of countermeasures suitable for implementation to prevent potential security attacks in an application. Discussions about threat modeling are typically within a context of software development lifecycle.

To perform a threat modeling activity, information representative of the application is described. A logical structure associated with an application can include elements such as components, roles, external dependencies, data, and so on. A break down of an application typically further identifies trust boundaries, data flows, entry points, and exit points. The identification of elements of an application, provide a capability to uncover threats and discover vulnerabilities associated with the application. The elements once extracted from the logical structure of the application form a basis for threat analysis and modeling. The process of extracting the one or more elements is typically referred to as application decomposition.

Application decomposition however is a lengthy process, which typically deters users from performing a threat modeling activity. During the threat modeling activity, a knowledgeable user has to characterize the application according to features mentioned comprising the technologies being used, the infrastructure on which the application is going to be deployed, the type of users and business.

Current solutions allow the knowledgeable user to manually specify these application features usually in the form of architectural diagrams showing topology of the application and application components. The process is manual, iterative and non-standardized also relying on input from and knowledge of the particular user. Typically the current solutions result in an incomplete list of threats.

### SUMMARY

Methods, computer program products, apparatus, and tools are provided for automated application decomposition.

According to one aspect, a computer-implemented method is provided for providing automated application decomposition. The method includes generating, by one or more external tools, a set of information specific to an application, and storing the generated set of information. Predefined heuristics and corresponding predefined conclusions are applied to the set of information to produce an intermediate result. The predefined heuristics and conclusions are categorized corresponding to each of a particular external tool domain. The intermediate result is converted into a set of conclusions about factors, representative of the application, used in application decomposition. The set of conclusions is exported and used to generate a model of the application. The model is a starting point for identification of threats and weaknesses specific to the application.

According to another aspect, a computer implemented method is provided for providing automated application decomposition. External tool data representative of an application is received. The received data is generated from one or more external tools. The received data is stored and aggregated. The aggregated data is analyzed, which includes applying a set of predefined heuristics and corresponding predefined conclusions to the aggregated data to produce analyzed data. The analyzed data is converted into an application model.

According to a yet another aspect, an apparatus is provided to provide automated application decomposition. The apparatus includes a collector to receive a set of information specific to an application generated by one or more external tools. The apparatus further includes an analyzer to apply predefined heuristics and corresponding predefined conclusions to the set of information to produce an intermediate result, and convert the intermediate result into a set of conclusions about factors used in application decomposition. The predefined heuristics and the corresponding predefined conclusions are categorized corresponding to one or more external tool domains, and the set of conclusions is representative of the application. The apparatus further includes an exporter to export the set of conclusions, and a generator to generate a model of the application based on the exported set. The model is a starting point for identification of threats and weaknesses specific to the application.

According to a further aspect, a computer program is provided to provide automated application decomposition. The computer program product includes a computer-readable storage device having computer-executable program code embodied therewith. The program is executable by a processor to generate, by one or more external tools, a set of information specific to an application, and store the generated set of information. Predefined heuristics and corresponding predefined conclusions are applied to the set of information to produce an intermediate result. The predefined heuristics and conclusions are categorized corresponding to each of a particular external tool domain. The intermediate result is converted into a set of conclusions about factors, representative of the application, used in application decomposition. The set of conclusions is exported and the exported set is used to generate a model of the application. The model is a starting point for identification of threats and weaknesses specific to the application.

According to an even further aspect, an apparatus is provided to provide automated application decomposition. The apparatus includes a communications fabric. A memory containing computer executable program code, a communications unit, an input/output unit, a display, and a processor unit are connected to the communications fabric. The processor unit executes the program code to direct the apparatus to receive a set of information specific to an application generated by one or more external tools. Predefined heuristics and corresponding predefined conclusions are applied to the set of information to produce an intermediate result. The predefined heuristics and conclusions are categorized corresponding to each of a particular external tool domain. The intermediate result is converted into a set of conclusions about factors, representative of the application, used in application decomposition. The set of conclusions is exported and the exported set is used to generate a model of the application. The model is a starting point for identification of threats and weaknesses specific to the application.

According to another aspect, a tool is provided to provide automated application decomposition. The tool includes a communications fabric. A memory containing computer executable program code, a communications unit, an input/output unit, a display, and a processor unit are connected to the communications fabric. The processor unit executes the program code to direct the apparatus to receive a set of information specific to an application generated by one or more external tools. The tool belongs to at least one category of tools, including application security tools providing information associated with testing and exploration traffic, security scan configurations, source code, and code libraries, network security devices providing information associated with network traffic including usage patterns, deployment information and network topology, and business modeling tools providing information typically associated with actors, business processes, user actions, and business assets. Predefined heuristics and corresponding predefined conclusions are applied to the set of information to produce an intermediate result. The predefined heuristics and conclusions are categorized corresponding to each of a particular external tool domain. The intermediate result is converted into a set of conclusions about factors, representative of the application, used in application decomposition. The set of conclusions is exported. The exported set is suitable to generate a model of the application. The model is a starting point for identification of threats and weaknesses specific to the application.

These and other features and advantages will become apparent from the following detailed description of the presently preferred embodiment(s), taken in conjunction with the accompanying drawings.

### BRIEF DESCRIPTION OF THE DRAWINGS

For a more complete understanding of this disclosure, reference is now made to the following brief description, taken in conjunction with the accompanying drawings and detailed description, wherein like reference numerals represent like parts.

FIG. 1 is a block diagram of an exemplary network data processing system operable for various embodiments of the disclosure;

FIG. 2 is a block diagram of an exemplary data processing system operable for various embodiments of the disclosure;

FIG. 3 is a block diagram representation of a decomposition system operable for various embodiments of the disclosure;

FIG. 4 is a block diagram of data structure representing tools and corresponding data relationship used in the decomposition system of FIG. 3 in accordance with one embodiment of the disclosure;

FIG. 5 is a block diagram of heuristic relationship data structure used in the decomposition system of FIG. 3 in accordance with one embodiment of the disclosure;

FIG. 6 is a graphic diagram of a mock user interface for a decomposition tool used in the decomposition system of FIG. 3 in accordance with one embodiment of the disclosure; and

FIG. 7 is a flowchart of an application decomposition process using the decomposition system of FIG. 3 in accordance with one embodiment of the disclosure.

### DETAILED DESCRIPTION

Although an illustrative implementation of one or more embodiments is provided below, the disclosed systems and/or methods may be implemented using any number of techniques. This disclosure should in no way be limited to the illustrative implementations, drawings, and techniques illustrated below, including the exemplary designs and implementations illustrated and described herein, but may be modified within the scope of the appended claims along with their full scope of equivalents.

As will be appreciated by one skilled in the art, aspects of the present disclosure may be embodied in which the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

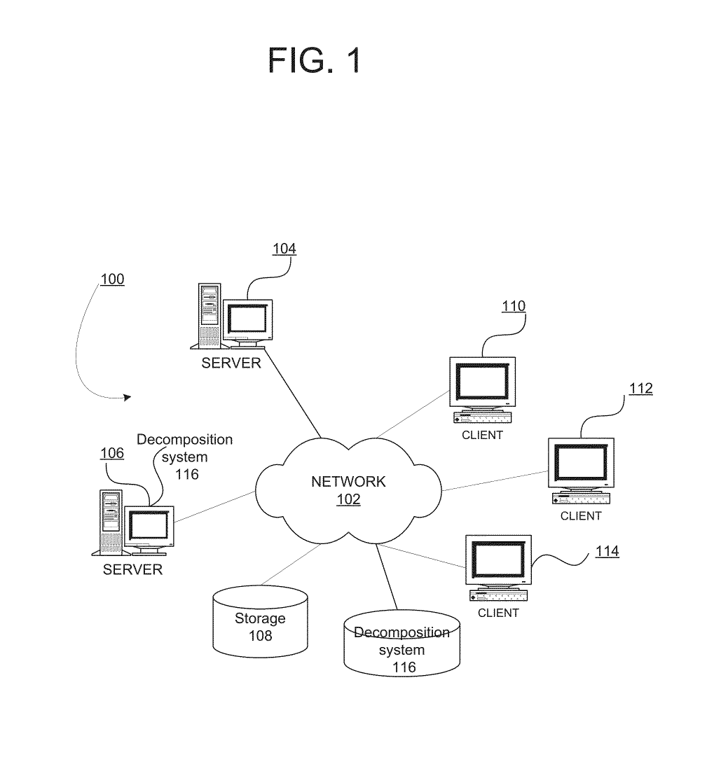

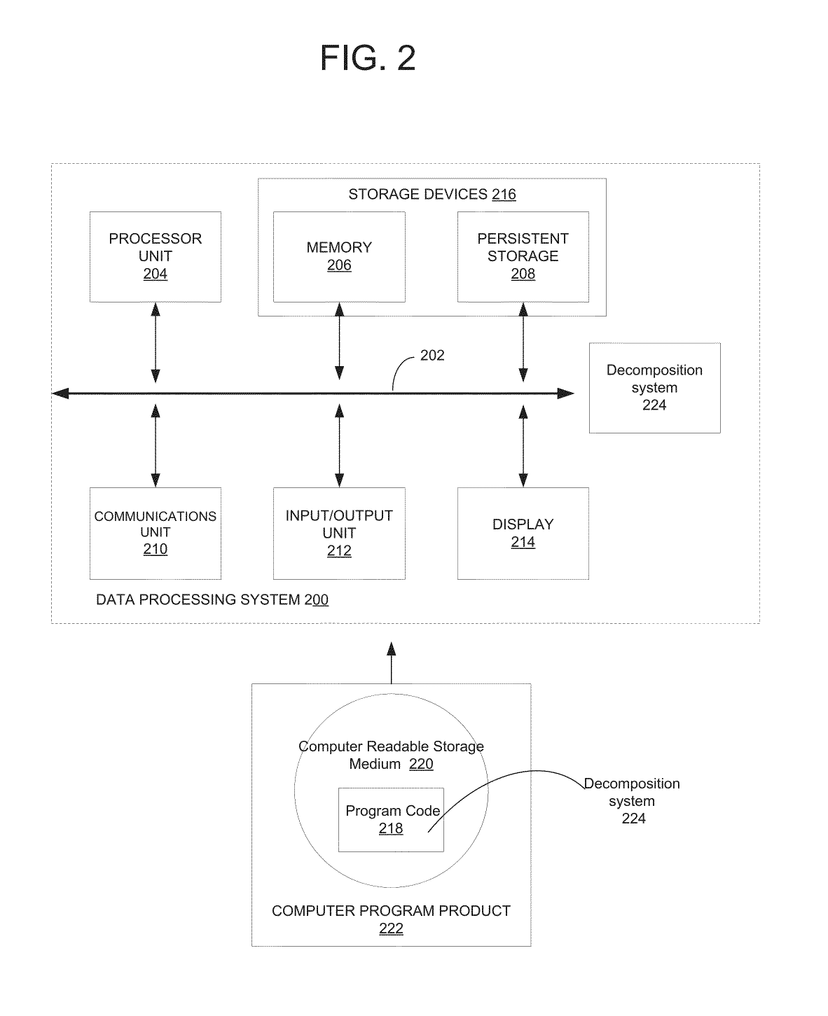

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 106 provides data, such as boot files, operating system images, and applications to clients 110, 112, 114 and decomposition system 116. Decomposition system 116 may also be maintained in a storage device and available for deployment on one or more of server 104 or server 106. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference to FIG. 2 a block diagram of an exemplary data processing system operable for various embodiments of the disclosure is presented. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example without limitation, data, program code in functional form, and/or other suitable information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications and/or programs, including decomposition system 224, may be located in storage devices 216, which are in communication with processor unit 204 through communications fabric 202. In these illustrative examples the instructions are in a functional form on persistent storage 208. These instructions may be loaded into memory 206 for execution by processor unit 204. The processes of the different embodiments may be performed by processor unit 204 using computer-implemented instructions, which may be located in a memory, such as memory 206.

These instructions are referred to as program code, computer usable program code, or computer readable program code that may be read and executed by a processor in processor unit 204. The program code, comprising instructions for execution by one or more processors of a data processing system, in the different embodiments may be embodied on different physical or tangible computer readable storage media, such as memory 206 or persistent storage 208.

Program code 218 is located in a functional form on computer readable storage media 220 that is selectively removable and may be loaded onto or transferred to data processing system 200 for execution by processor unit 204. Program code 218, including decomposition system 224 stored on computer readable storage media 220 form computer program product 222 in these examples. In one example, computer readable storage media 220 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable storage media 220 also may take the form of a persistent storage, such as a hard drive, a thumb drive, or a flash memory that is connected to data processing system 200. The tangible form of computer readable storage media 220 is also referred to as computer recordable storage media or a computer readable data storage device. In some instances, computer readable storage media 220 may not be removable.

Alternatively, program code 218 may be transferred to data processing system 200 from computer readable storage media 220 through a communications link to communications unit 210 and/or through a connection to input/output unit 212. The communications link and/or the connection may be physical or wireless in the illustrative examples.

In some illustrative embodiments, program code 218, including decomposition system 224, may be downloaded over a network to persistent storage 208 from another device or data processing system for use within data processing system 200. For instance, program code stored in a computer readable data storage device in a server data processing system may be downloaded over a network from the server to data processing system 200. The data processing system providing program code 218 may be a server computer, a client computer, or some other device capable of storing and transmitting program code 218.

Using data processing system 200 of FIG. 2 as an example, a computer-implemented process for automated application decomposition is presented. Processor unit 204 collects a set of information specific to an application by a plurality of external tools. Processor unit 204 applies predefined heuristics and corresponding predefined conclusions, categorized corresponding to each of a particular external tool domain, to the set of information collected by the plurality of external tools to create an intermediate result. The intermediate result is analyzed by processor unit 204 to form a set of conclusions about factors, representative of the application, used in application decomposition.

Processor unit 204 using the set of conclusions exported generates a model of the application, wherein the model is a starting point for identification of threats and weaknesses specific to the application. The computer-implemented process for automated application decomposition provides integration between an existing threat modeling tools and external software for the purpose of automated application decomposition.

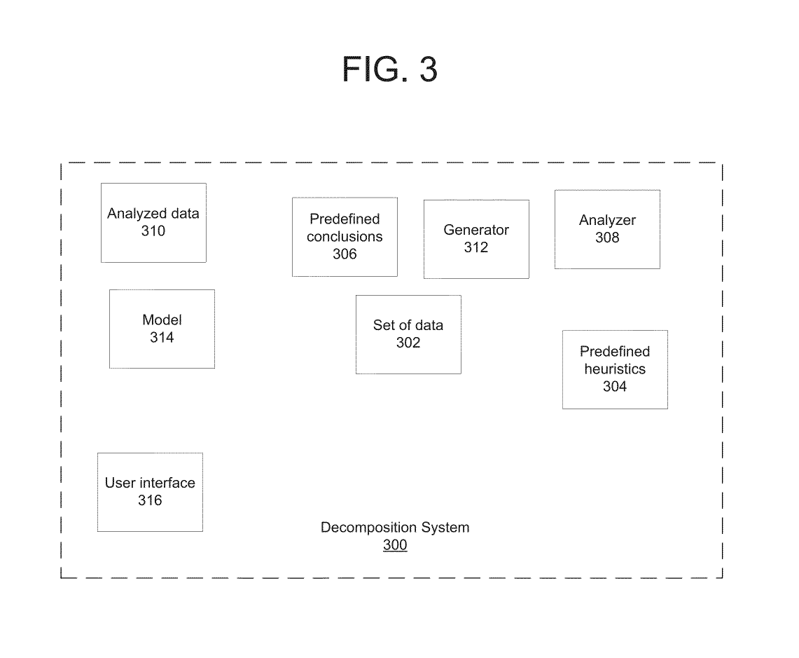

With reference to FIG. 3 a block diagram of a decomposition system operable for various embodiments of the disclosure is presented. Decomposition system 300 is an example of a system for programmatic decomposition of an application for use in threat modeling. Decomposition system 300 enables the integration of scanned result data into a format for use in a threat modeling tool and model instance.

Decomposition system 300 provides a set of capabilities to fulfill programmatic decomposition of an application using a set of interdependent components comprising sets of data 302, predefined heuristics 304, predefined conclusions 306, analyzer 308, analyzed data 310, generator 312, model 314, and user interface 316. Decomposition system 300 relies upon and leverages the capabilities and services of an underlying data processing system, for example, network data processing 100 of FIG. 1 or data processing system 200 of FIG. 2.

The example of decomposition system 300 is not intended to be limited to the implementation depicted and is only provided for illustration purposes. One skilled in the art would readily construe other variations including combining one or more components into one or more integrated components to be an equivalent representation within the scope of the current example.

Set of data 302 comprises an aggregation of raw data resulting from multiple, heterogeneous types of scanning and data generation tools which are typically external (to the application) tools. Each member of set of data 302 includes a variety of factors used in application decomposition. Data resulting from each of the multiple, heterogeneous types of external tools (may also be referred to as a third party tool) are collected from the external tools into a respective instance of a member in set of data 302. An external tool (for example, a security scanner) generates the raw data, which is later used in a particular form as subsequent input to a threat modeling tool used to identify potential threats.

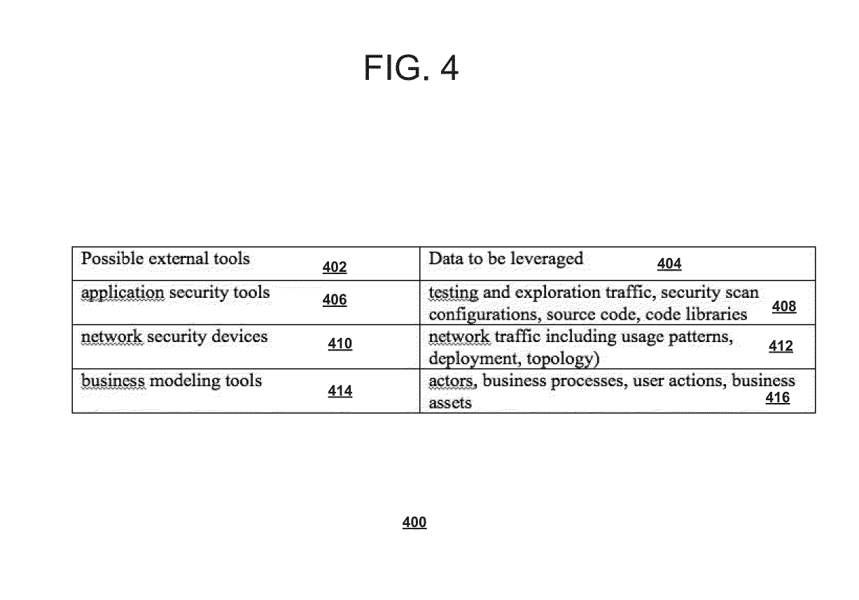

Set of data 302 accordingly forms a collection of information required to start a threat modeling process. Each member in set of data 302 corresponds to results obtained from use of a specific third party tool. The result is maintained in one of a format provided by the specific third party or in a common format across third party tools. As disclosed, decomposition system 300 does not require the raw data to be transformed into a common format. A decision to transform the raw data into a common format is therefore optional as an implementation choice, but is not a current requirement of the disclosed method. An example of typical types of tools and data generated by a respective type of tool is provided in FIG. 4.

Predefined heuristics 304 is a set of heuristics applied to set of data 302, provided by the third party tools, to draw conclusions from predefined conclusions 306 associated with a variety of factors used in application decomposition. Predefined heuristics 304 are categorized based on the data provided by the third party tool as set of data 302. Predefined heuristics 304 limits a search for solutions in domains of the data types by enabling decisions based upon the information provided in the form of a matching of the data type and an associated predefined heuristic with a conclusion.

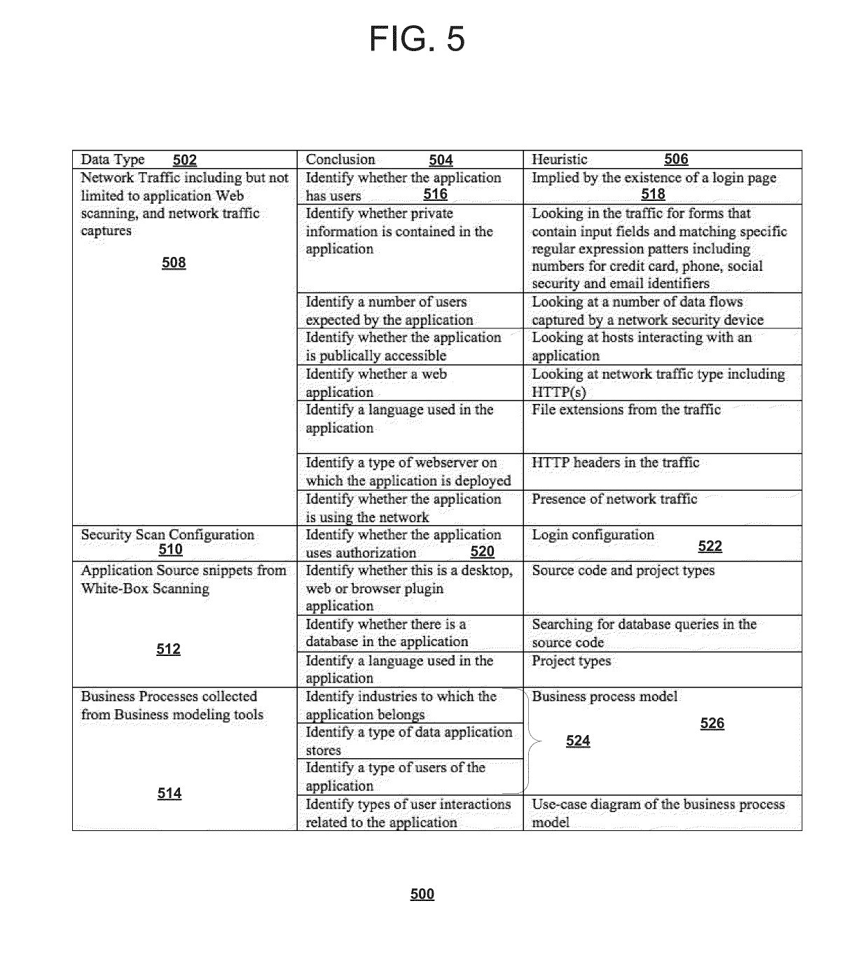

Predefined conclusions 306 provide a set of conclusions associated with one or more predefined heuristics 304 for a particular data type of set of data 302. For example in a particular domain or data type, and an instance of a given heuristic defines a specific corresponding conclusion. The predefined relationship of the tuple comprising the data type, the heuristic and the conclusion identifies the data captured and purpose. A data structure providing a set of example heuristic relationships is described in FIG. 5.

Analyzer 308 provides a capability to receive one or more members of set of data 302 corresponding to results obtained from use of one or more receptive specific third party tools. Analyzer 308 applies one or more selected predefined heuristics 304 categorized corresponding to each of the particular external tool domains in the set of information collected by the plurality of external tools in accordance with the particular member of set of data 302 and matching with a corresponding one of predefined conclusions 306 to provide a particular resolution.

Set of data 302 in a form of an aggregation is processed by analyzer 308 to yield analyzed data 310. Each member of set of data 302 is processed according to a respective data type. Members of set of data 302 are not combined into a combination of more than one data type or data from more than one tool of a same or different type. Analyzed data 310 represents a processed version of respective members of set of data 302. Analyzed data 310 is an intermediate form exported for use in subsequent processing as input to generator 312.

Generator 312 provides a capability to receive as input the process data of analyzed data 310 and produce model 314 as a result. In one embodiment generator 312 also includes a user interface 316 for further refining analyzed data 310, which is used to populate various fields of user interface 316. When no user interface is present, generator 312 operates in silent mode to produce model 314.

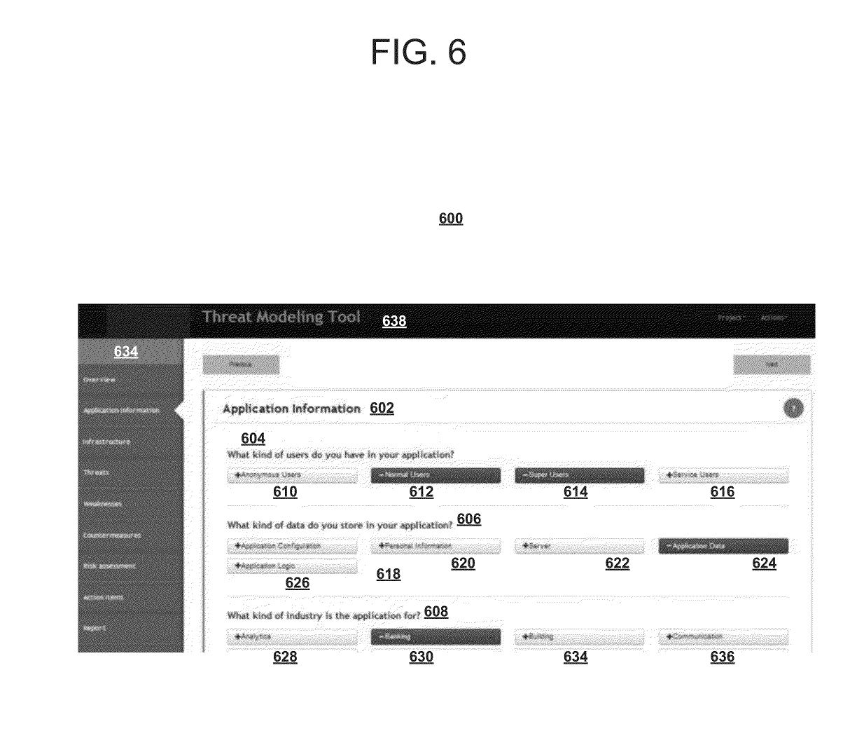

Generator 312 provides a set of transforms used to process each respective member of analyzed data 310 into model 314, which is used to start a threat modeling process as a starting point for identification of threats and weaknesses that apply to the particular application. An example of an embodiment of user interface 316 is provided and further described in FIG. 6.

With reference to FIG. 4 a block diagram of data structure representing external tools and corresponding data relationship used in the decomposition system of FIG. 3 in accordance with one embodiment of the disclosure is provided. Data structure 400 is an example representation of an in memory structure defining one or more external data collection tools and a corresponding data generated by and collected from a respective one or more the external data collection tools used in an embodiment of decomposition system 300 of FIG. 3.

In the current example, data structure 400 is depicted in tabular form but as appreciated by one skilled in the art other variations may also be defined including a simple list. Data structure 400 defines a relationship between a particular category of external tools 402 and corresponding data 404 generated by using a tool of the particular category. A category may also be referred to herein as a domain or external tool domain.

For example, when a tool belongs to a category of application security tools 406 corresponding data 408 is available. Corresponding data 408 provides information typically associated with testing and exploration traffic, security scan configurations, source code, and code libraries. In a further example, the category of network security devices 410 provides information typically associated with network traffic 412 including usage patterns, deployment information and network topology. In a further example, the category of business modeling tools 414 provides information typically associated with actors, business processes, user actions, and business assets 416.

Data structure 400 may also be used in the form of a checklist of information to be collected and sources available from which to collect the required information. Data structure 400 defines possible sources of associated information from which set of data 302 of FIG. 3 is obtained.

With reference to FIG. 5 a block diagram of heuristic relationship data structure used in the decomposition system of FIG. 3 in accordance with one embodiment of the disclosure is provided.

In the current example, data structure 500 is depicted in tabular form but as appreciated by one skilled in the art other variations may also be supported include comma separated values or linked list, hash table, binary search tree, an associative array, map, symbol table, or dictionary of an abstract data type comprising a collection of (key, value) pairs, in which each of the possible key values appears no more than one time in a respective collection. For example within a particular data type of network traffic there is only one instance of a specific heuristic and therefore only one corresponding matching conclusion for the given combination the particular data type and specific heuristic. Data structure 500 maintains a set of data used in search operations performed using analyzer 308 of FIG. 3.

Data structure 500 is depicted in a singular tabular form but may be stored as a set of data structures in which each category or data type is saved as a separate structure. These sub-structures may then be accessed to perform a lookup using a tuple of a data type and heuristic to pull a corresponding conclusion during an analysis phase of processing.

Data structure 500 in the example includes headings of data type 502, conclusion 504 and heuristic 506 to define the contents of the table in the view. In this example, data types of category 508-514 are defined. Each row in data structure 500 accordingly defines an association between data type 502 and a combination of one or more conclusion 504 with one or more heuristic 506. For example in category 508 defining network traffic there is a one to one correspondence between each of heuristics 506, in this case heuristic 518, and respective conclusions 504, in this case conclusion 516. In a similar manner category 510 defines a relationship between heuristic 522 and conclusion 520. However in category 514 there is an example of a one to many relationship between a single heuristic 526 and multiple conclusions 524.

In the example of category 514, data extraction representative of business process as in heuristic 526 includes specific data to resolve conclusions 524 comprising identifying industries to which the application belongs, identifying a type of data stored by the application and identifying types of users of the application. When analyzer 308 of FIG. 3 is running in silent mode multiple fields of analyzed data would be populated. Whereas when user interface 316 of FIG. 3 is used a user may be prompted to verify and refine the data presented as multiple filed values.

Analyzer 308 of FIG. 3 uses the content of data structure 500 to parse the raw data of set of data 302, according to a respective data type category, such as one of categories category 508-514. As disclosed previously, data structure 500 may be implemented a set of one or more structures. When multiple structures as described are used data structure 500 may be sub-divided so each sub-structure is one specific category enabling efficient search using a combination of data type 502 and heuristic 506 to resolve to a particular conclusion 504 (or as in the case of category 514 a set of conclusions 524).

With reference to FIG. 6 a graphic diagram of a mock user interface for a decomposition tool used in the decomposition system of FIG. 3 in accordance with one embodiment of the disclosure is provided. User interface 600 is an example of a graphical user interface for collection and refinement of raw data obtained from one or more external tools used to generate data representative of a particular application of interest.

User interface 600 represents a portion of a user interface as maybe used by a user to further refine (or provide additional) data obtained from one or more external tools used to extract information describing characteristics of an application of interest. Continuing the example of FIG. 5, threat modeling tool 638 comprises a number of sections, each selection further comprising a number of fields including fields 604-608 which prompt a user for data representative of business process as in heuristic 526 including specific data to resolve conclusions 524 comprising identifying types of users of the application, identifying a type of data stored by the application, and identifying a type of industry to which the application belongs. In the current example, a selection of application information 602 from navigation area 634 opens a dialog portion of application information 602. Highlighted portions, including fields 612 and 614, include information presumed previously populated by generator 312 of FIG. 3.

Fields 604 identify a set of fields indicating a specification of four types of users including anonymous users 610, normal users 612, super users 614 and service users 616. Fields 606 identify a set of fields indicating a specification of five types data stored including application configuration 618, personal information 620, server 622, application data 624 and application logic 626. Fields 608 identify a set of fields indicating a specification of four kinds of industry including analytics 628, banking 630, building 634 and communication 636.

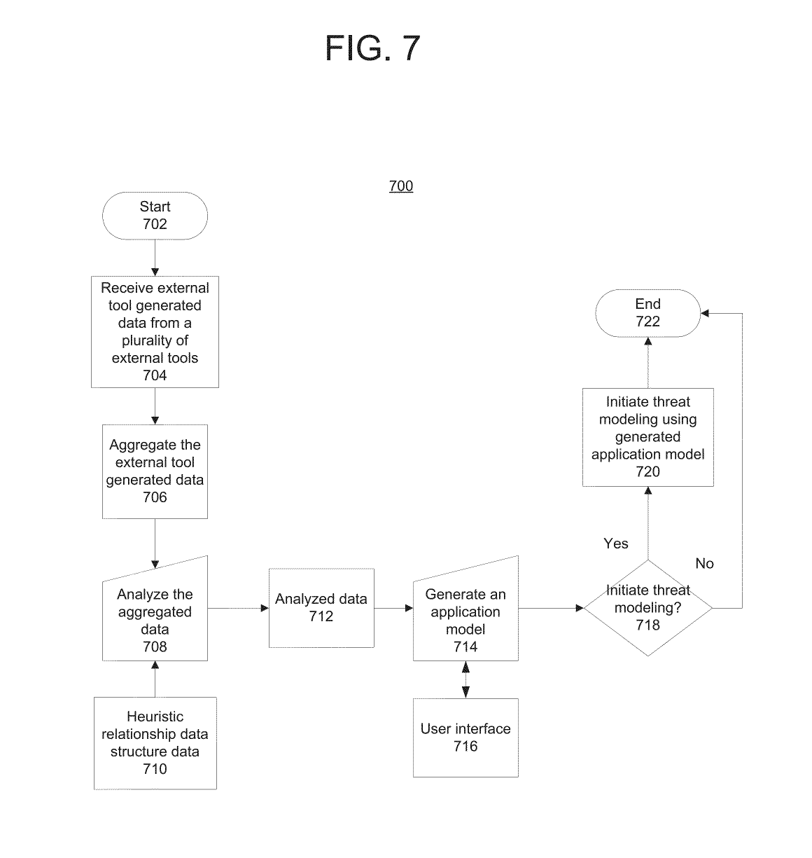

With reference to FIG. 7 a flowchart of an overview of an application decomposition process using the decomposition system of FIG. 3 in accordance with one embodiment of the disclosure is provided.

Process begins (step 702) and receives external tool generated data from a plurality of external tools (step 704). The plurality of external tools represent one or more tools used to gather information on one or more aspects of an application including network metrics, security scan configuration, application source snippets and business processes collected from business modeling tools.

Process 700 aggregates the external tool data (step 706). Data aggregation does not combine the data into a homogenous mass; rather aggregation collects data from the plurality of external tools and maintains the data in accordance with a respective category and respective tool to maintain the integrity of the data. In an alternative embodiment an optional normalization of the data may be performed prior to providing the data for analysis, but this normalization is not required and would be implementation specific.

Process 700 analyzes the aggregated data (step 708). Analysis comprises parsing the respective category and tool data using definitions provided by a heuristic relationship data structure 710 comprising for each data type of a category of tool generated data a set of predefined heuristics and a corresponding set of predefined conclusions. During analysis process 700 matches a combination of the data type of the particular category of tool generated data and the associated predefined heuristics to the corresponding set of predefined conclusions.

Process 700 creates analyzed data 712 as a result of analyzing the aggregated data. Process 700 generates an application model using the analyzed data 712 as input (step 714). The application model comprises a description of characteristics of the application in accordance with the raw data provided by the plurality of external tools. The application model may be generated in one of a selected modeling language as required for input by a subsequent modeling tool. When provided, user interface 716 may also be used to further refine the result of parsing the external tool data and/or to provide additional data as required supplementing the external tool data. Optionally the generator may create an application model in a selected format specific to a particular threat modeling tool rather than a universal model. An optional step may also transform the model generated into a format suited to a specific threat modeling tool.

Process 700 determines whether to initiate threat modeling (step 718). Threat modeling is a subsequent modeling activity using the generated application model of step 714 as input. In response to a determination to not initiate threat modeling (a normal response) process 700 terminates thereafter (step 722). In response to a determination to initiate threat modeling process 700 initiates threat modeling using the generated application model (step 720) and terminates thereafter (step 722).

Process 700 therefore describes a high level view of a method for automated application decomposition using data obtained from external tools for use in threat modeling. Process 700 includes a number of operations comprising collecting a set of information specific to an application by a plurality of external tools, wherein the set of information includes information comprising information associated with a particular external tool domain including at least an application security tool domain, a network security tool domain and a business modeling tool domain; applying a series of heuristics categorized corresponding to each of the particular external tool domains to the set of information collected by the plurality of external tools to create a result; and analyzing the result to form a set of conclusions about factors used in application decomposition, wherein the set of conclusions is exported for use in constructing a model of the application and as a starting point for identification of threats and weaknesses that apply to the application.

Thus is presented in an illustrative embodiment a computer-implemented process for automated application decomposition. The computer implemented process collects a set of information specific to an application by a plurality of external tools and applies predefined heuristics and corresponding predefined conclusions, categorized corresponding to each of a particular external tool domain, to the set of information collected by the plurality of external tools to create an intermediate result. The intermediate result is analyzed to form a set of conclusions about factors, representative of the application, used in application decomposition. A model of the application is generated using the set of conclusions exported, wherein the model is a starting point for identification of threats and weaknesses specific to the application.

In another embodiment a computer-implemented process for automated application decomposition comprises receiving external tool generated data, representative of an application, from a plurality of external tools. The external tool data is aggregated. The aggregated data is analyzed using a set of predefined heuristics and a set of predefined conclusions to create analyzed data. The analyzed data is used to generate an application model. The application model will be used in a threat modeling environment.

In another embodiment an apparatus for automated application decomposition, comprises a collector of a set of information specific to an application generated by a plurality of external tools. The apparatus further comprises an analyzer which applies predefined heuristics and corresponding predefined conclusions, categorized corresponding to each of a particular external tool domain, to the set of information collected from the plurality of external tools to create an intermediate result to analyze the intermediate result to form a set of conclusions about factors, representative of the application, used in application decomposition. An exporter exports the set of conclusions for subsequent use. A generator constructs a model of the application using the set of conclusions exported; wherein the model constructed is a starting point for identification of threats and weaknesses specific to the application.

In another embodiment a tool for automated application decomposition comprises a communications fabric; a memory connected to the communications fabric, wherein the memory contains computer executable program code; a communications unit connected to the communications fabric; an input/output unit connected to the communications fabric; a display connected to the communications fabric; and a processor unit connected to the communications fabric. The processor unit executes the computer executable program code to direct the apparatus to generate a set of information specific to an application by the tool, wherein the tool belongs to at least one category of tools comprising an application security tools providing information associated with testing and exploration traffic, security scan configurations, source code, and code libraries; network security devices providing information associated with network traffic including usage patterns, deployment information and network topology; business modeling tools providing information typically associated with actors, business processes, user actions, and business assets, and wherein the set of information is raw data resulting from at least one of multiple, heterogeneous types of scanning and data generation of the tool.

The processor unit further executes the computer executable program code to direct the apparatus to apply predefined heuristics and corresponding predefined conclusions, categorized corresponding to a particular external tool domain, and to the set of information collected by the tool to create an intermediate result. The processor unit executes the computer executable program code to further direct the apparatus to analyze the intermediate result to form a set of conclusions about factors representative of the application used in application decomposition.

The processor unit executes the computer executable program code to direct the apparatus to export the set of conclusions, wherein the set of conclusions exported, is suitable to generate a model of the application provides integration between an existing threat modeling tool and the tool for automated application decomposition and wherein the model is a starting point for identification of threats and weaknesses specific to the application.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing a specified logical function. It should also be noted that, in some alternative implementations, the functions noted in the block might occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, and other software media that may be recognized by one skilled in the art.

It is important to note that while the present invention has been described in the context of a fully functioning data processing system, those of ordinary skill in the art will appreciate that the processes of the present invention are capable of being distributed in the form of a computer readable data storage device having computer executable instructions stored thereon in a variety of forms. Examples of computer readable data storage devices include recordable-type media, such as a floppy disk, a hard disk drive, a RAM, CD-ROMs, DVD-ROMs. The computer executable instructions may take the form of coded formats that are decoded for actual use in a particular data processing system.

A data processing system suitable for storing and/or executing computer executable instructions comprising program code will include one or more processors coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

What is claimed is:

1. A computer-implemented method for providing automated application decomposition, the method comprising:
generating, by one or more external tools, a set of information specific to an application;
storing the generated set of information;
applying predefined heuristics and corresponding predefined conclusions to the set of information to produce an intermediate result, wherein the predefined heuristics and the corresponding predefined conclusions are categorized corresponding to one or more external tool domains;
converting the intermediate result into a set of conclusions about factors used in application decomposition, and exporting the set of conclusions, wherein the set of conclusions is representative of the application; and
generating a model of the application based on the exported set of conclusions, wherein the model is a starting point for identification of threats and weaknesses specific to the application.

2. The method of claim 1, wherein the set of information comprises information associated with the one or more external tool domains, and wherein the one or more external tool domains are selected from the group consisting of: an application security tool domain, a network security tool domain, and application source domain, a business modeling tool domain, and combinations thereof.

3. The method of claim 1, wherein each predefined heuristic and corresponding predefined conclusions is associated with a respective external tool domain to form a data structure, and wherein each predefined heuristic is mapped to a respective predefined conclusion.

4. The method of claim 1, further comprising aggregating the set of information according to each external tool domain, including aggregating each external tool domain to each external tool.

5. A computer-implemented method for providing automated application decomposition, the method comprising:
receiving external tool data representative of an application, wherein the received data is generated from one or more external tools;
storing the received data;
aggregating the stored data;
analyzing the aggregated data, including applying a set of predefined heuristics and corresponding predefined conclusions to the aggregated data to produce analyzed data; and
converting the analyzed data into an application model.

6. The process of claim 5, wherein the received data comprises information associated with each of a plurality of external tool domains, and wherein the one or more external tools are selected from the group consisting of: an application security tool domain, a network security tool domain, and application source domain, a business modeling tool domain, and combinations thereof.

7. The process of claim 5, wherein each predefined heuristic and corresponding predefined conclusions is associated with a respective external tool domain to form a data structure, and wherein each predefined heuristic is mapped to a respective predefined conclusion.

8. The process of claim 7, wherein the data structure describes a single particular external tool domain and associated predefined heuristics and the corresponding predefined conclusions.

9. The computer-implemented process of claim 5, wherein the aggregation comprises program code to aggregate the stored data according to each external tool domain, including program code to aggregate each external tool domain to each external tool.

10. An apparatus to provide automated application decomposition, comprising:
a collector, the collector to receive of a set of information specific to an application generated by one or more external tools;
an analyzer, the analyzer to:
apply predefined heuristics and corresponding predefined conclusions to the set of information to produce an intermediate result, wherein the predefined heuristics and the corresponding predefined conclusions are categorized corresponding to one or more external tool domains; and
convert the intermediate result into a set of conclusions about factors used in application decomposition, wherein the set of conclusions is representative of the application;
an exporter to export the set of conclusions; and
a generator to generate a model of the application using the set of conclusions exported, wherein the model is a starting point for identification of threats and weaknesses specific to the application.

11. A computer program product to provide automated application decomposition, the computer program product comprising a computer-readable storage device having computer-executable program code embodied therewith, the program code executable by a processor to:
generate, by one or more external tools, a set of information specific to an application;
store the generated set of information;
compare predefined heuristics and corresponding predefined conclusions with the stored set of information to produce an intermediate result, wherein the predefined heuristics and the corresponding predefined conclusions are categorized corresponding to each of a particular external tool domain;
convert the intermediate result into a set of conclusions about factors used in application decomposition, and export the set of conclusions, wherein the set of conclusions is representative of the application; and
generate a model of the application based on the exported set of conclusions, wherein the model is a starting point for identification of threats and weaknesses specific to the application.

12. The computer program product of claim 11 wherein the set of information includes information comprising information associated with a particular external tool domain, and wherein the one or more external tools domains are selected from the group consisting of: an application security tool domain, a network security tool domain, and application source domain, a business modeling tool domain, and combinations thereof.

13. The computer program product of claim 12, wherein each predefined heuristic is mapped to a respective predefined conclusion, and wherein the predefined heuristics and predefined conclusions are associated with an external tool domain to form a data structure.

14. The computer program product of claim 13, wherein the data structure describes a single external tool domain and associated predefined heuristics and the corresponding predefined conclusions.

15. The computer program product of claim 12 further comprising program code to aggregate the set of information according to each particular external tool domain, including program code to aggregate each external tool domain to each external tool.

16. An apparatus to provide automated application decomposition, the apparatus comprising:
a communications fabric;
a memory connected to the communications fabric, wherein the memory contains computer executable program code;
a communications unit connected to the communications fabric;
an input/output unit connected to the communications fabric;
a display connected to the communications fabric; and
a processor unit connected to the communications fabric, wherein the processor unit executes the computer executable program code to direct the apparatus to:
receive a set of information specific to an application generated by one or more external tools;
apply predefined heuristics and corresponding predefined conclusions to produce an intermediate result, wherein the predefined heuristics and the corresponding predefined conclusions are categorized corresponding to one or more external tool domains;
convert the intermediate result into a set of conclusions about factors used in the application decomposition, wherein the set of conclusions is representative of the application;
export the set of conclusions; and
generate a model of the application based on the exported set, wherein the model is a starting point for identification of threats and weaknesses specific to the application.

17. A tool to provide automated application decomposition, the tool comprising:
a communications fabric;
a memory connected to the communications fabric, wherein the memory contains computer executable program code;
a communications unit connected to the communications fabric;
an input/output unit connected to the communications fabric;
a display connected to the communications fabric; and
a processor unit connected to the communications fabric, wherein the processor unit executes the computer executable program code to direct the apparatus to:
generate a set of information specific to an application by a tool, wherein the tool belongs to one or more categories of tools, the one or more categories selected from the group consisting of:
application security tools providing information associated with testing and exploration traffic, security scan configurations, source code, and code libraries;
network security devices providing information associated with network traffic including usage patterns, deployment information and network topology;
business modeling tools providing information typically associated with actors, business processes, user actions, and business assets, and combinations thereof; and
wherein the set of information is raw data resulting from at least one of multiple, heterogeneous types of scanning and data generation of the tool;
apply predefined heuristics and corresponding predefined conclusions to the set of information to produce an intermediate result, wherein the predefined heuristics and the corresponding predefined conclusions are categorized corresponding to a particular external tool domain;
convert the intermediate result into a set of conclusions about factors used in application decomposition, wherein the set of conclusions is representative of the application; and
export the set of conclusions, wherein the exported set is suitable to generate a model of the application, and wherein the model is a starting point for identification of threats and weaknesses specific to the application.
